(19) United States
(12) Patent Application Publication
(10) Pub. No.: US 2004/0137109 A1
(43) Pub. Date: Jul. 15, 2004

(54) Process for controlled evolution of wines and relevant realisation device

(76) Inventors: Fabio Guglielmi, Roma (IT); Cleto Simoncelli, Grottaferrata (IT)

Correspondence Address: Abelman Frayne & Schwab, 150 East 42nd Street, New York, NY, 10017-5612, US

(21) Appl. No.: 10/467,898

(22) PCT Filed: Feb. 11, 2002
(86) PCT No.: PCT/EP02/01394

(30) Foreign Application Priority Data
Feb. 12, 2001 (IT) RM1A000070

(51) Int. Cl. C12C 11/00

(52) U.S. Cl. 426/11

(57) ABSTRACT

In the evolution processes of wines, the passage through the wine itself of continuous electric micro-currents permits to reach, in metal oxygen-impermeable containers, results comparable to those obtained in wood barrels. At least the anode utilised for feeding said micro-currents must be definitively titanium-made, and preferably the wine container is also titanium-made and can work as an anode.

### FIELD OF INVENTION

Present invention refers to a process for the controlled evolution of wines and relevant realisation device; more precisely, the invention refers to a process responsible for the product evolution in which the redox reactions in the wine are promoted, accelerated and controlled by means of electric micro-currents passing between titanium electrodes, to the relevant realisation device and to the utilisation of said currents for the controlled evolution of wines.

### STATE OF THE ART

The organoleptic characteristics of wines, and hence relevant quality, depend on evolution processes of some of wine components due e.g. to polymerisation and etherification reactions which modify and produce some substances such as aldehydes, acetals and lactones, responsible for said organoleptic characteristics. Such reactions are promoted by the oxygen dissolved in small quantity into the wine and mainly involve polyphenolic components thereof. The extension and speed of said evolution processes depend on a number of factors, among which can be mentioned the length of the storage period, the wine composition and the material of which the evolution containers are made of (wood, cement, stainless steel, epoxy resins, and so on). The course of the above mentioned evolution or maturation mainly depends on redox reactions exploiting the oxygen dissolved into the wine. Because of said reactions, the historically and technically best choice material for the maturation containers is wood, which not only releases to the wine some compounds such as tannins, but due to its porosity also permits a certain slow oxygenation of the wine, thus allowing the maturation reactions to proceed with time. Thus, small wooden barrels (barriques) were introduced which, for some type of wine, present an optimal surface/volume ratio and hence adequate effects on micro-oxygenation and release of aromas proper of the specific wood. Such barrels, however, are relatively expensive (at the moment about 1000 Euro each) and must be frequently substituted (every about 2-3 years), also because relevant internal surfaces become less and less permeable with time and hence less apt to the maturation. For high-quality wines the final retail price justifies the additional good quality, such an additional cost is usually unbearable. Thus, for the latter wines other materials are preferred for the maturation containers, such as stainless steels and epoxy resins, which however are oxygen-impermeable, thus being not apt to the evolution of quality wines, particularly red ones; such materials however present a number of very interesting, mainly economic advantages (In particular their very long life). Many attempts were made to extend the utilisation of such oxygen-impermeable materials by developing specific wine-evolution techniques, for instance through calibrated oxygen or air additions by means of gas micro-dosing devices. Such techniques were found not entirely satisfying, in that they do not allow a precise monitoring and control of the oxidative process, which should be a function of the phenolic structure of the wine and of its specific evolution.

Some attempts were also made to utilise direct electric current to treat wine, liquors and the like.

For Instance, E. M. Shpritsman et al (Moldavskii Nauchno-Issled. Inst. Phishchevol Promyshlennos; Sadovostvo, Vinogradarstvo I vinodelie Moldavii) described a method to stabilise wine by electrochemically elimination of oxygen.

DE-A 1442342 refers to a treatment with relatively high voltage and currents of wine, liquors and the like, In which anode and cathode are not separated, so as to permit contemporaneous decomposition and re-composition of a number of constituents of the treated liquid.

GB 428853 refers to an improvement in the condition of alcoholic liquids by adding to them small amounts of some elements, such as silver, also by means of electrochemical dissolution.

At the moment the possibility to carry-out a correct evolution of quality wines in non-wooden containers is unsatisfied.

### DESCRIPTION OF THE INVENTION

An object of present invention is to disclose a process enabling to carry-out a correct wine evolution in oxygen-impermeable containers.

Another object of present invention is to permit to carry-out in said oxygen-impermeable containers a controlled evolution of high-quality wines.

Still another object of present invention is to disclose a device permitting to carry-out said process for the controlled evolution of wines.

According to present invention, a wine contained in an oxygen-impermeable container is submitted to the action of continuous electric microcurrents made to pass through the wine itself by means of at least a couple of electrodes of which at least the anode is titanium-made and/or, as an alternative, it is the titanium made container itself that works as an anode.

The experiments carried out up to the moment revealed that the value of said micro-currents and the treatment duration are both interconnected and a function of the desired result and of the type of wine to be treated. As far as the currents are concerned, too low values prolong too much in time the duration of the treatment, thus resulting in an anti-economic process, while too high currents can have scarcely controllable effects, for instance due to a too rapid development of the reactions. The data up to now gathered permitted to define as usefully utilisable density currents values in the range comprised between 1 and 500 μA/m² of electrode, preferably between 5 and 200 μA/m², more preferably between 10 and 100 μA/m². However, very recent data, not yet fully elaborated, allow to affirm that a more accurate process control according to present invention can be obtained expressing the current density in μA per volume unit of treated wine, said current density being in the range of between 0,1 to 100 μA/l of wine, preferably between 0,1 and 50 μA/l, still more preferably between 1 and 10 μA/l. As far as duration of process is concerned, the above considerations utilised for the current density can also apply; in the experiments carried-out up to now, a duration comprised between 15 and 120 days gave good results. We cannot exclude, however, that different treatment duration could give acceptable results. As already affirmed above, in the process according to present invention at least the anode must be titanium-made, in that the liberated titanium ions micro-biologically interact in a positive way with some enzymatic processes (e.g., alcoholic fermentation and pentoses cycle). It is important to note, also in view of the necessary attention to-day paid to exogenous materials introduced into food, that titanium is, in the working conditions according to present invention, practically insoluble when subjected to anodic currents thus being unable to release significant amount of ions which could modify the taste of wine, the released amount of ions having in any case no influence at all on the human organism and on the consumer's health, being titanium fully bio-compatible.

The above-described process is opportunely carried out utilising a device comprising: (i) at least a wine container; (ii) a group of electrodes, anode and cathode, in which at least the anode is titanium-made and have a high surface development; (iii) an electric power supply group, electrically connected to said electrodes and comprising means, known per se, for controlling, measuring and supplying a continuous electric current to the electrodes as well as to measure and control the electrode anodic potential.

Preferably, the container itself can be titanium made, and can be the anode. Preferably, the surface development of each electrode is comprised between 10 m² and 0,1 m² per cubic meter of wine.

In a second embodiment, the reactions for the wine treatment are continuously carried out in at least a conduit, through which the wine is circulated and in which the electrodes are opportunely placed; the conduit can be titanium-made and can constitute the anode.

After this oxidation process and before bottling, the wine must undergo a stabilisation treatment, to prevent further modification of the wine characteristics in the bottle, usually carried out by addition to the wine of chemicals (i.e. sodium metabisulphide). However, particularly with quality wines, current tendency is to lower the use of such additions, both of the slightly toxic nature of this compound and of the desiderability to avoid the addition of foreign compounds to the wine thus altering its genuineness.

Present inventors found that the same effect of putting a halt to further modifications of wine after bottling, can be advantageously obtained by simply inverting the polarity of electrodes. In that case both the electrodes must be titanium made

To prevent any contrast between anodic and cathodic reactions, the electrodes can be separated by a wall permitting the chemical separation of the anodic zone from the cathodic one, yet permitting electrical contact. This is obtained, for instance, by interposing a ceramic septum having controlled porosity or an ion-exchange membrane.

Present invention will now be described in greater detail with reference to an exemplary embodiment, absolutely not limitative of the objects and scope of invention itself.

### EXAMPLE

Three 50 l samples of a same wine were stored in three containers, the first being glass-made, and the other two in titanium made. Through the wine in the first titanium container a continuous current was made to pass of 1 μA/m² of electrode while the wine in the second titanium container was subjected to a continuous current of 10 μA/m². In both cases the container was the anode, while the cathode was an elongated bar-shaped titanium electrode.

The wine in the glass container was not treated at all.

In both titanium containers, the current was maintained unchanged for 60 days, after which all the three samples were chemically analysed for some important components and sensorially tested by a group of 15 qualified experts, according to the UNI ISO 5496, 1987 standard; the results are given in the following Tables, the first one containing the chemical analysis results, while the second one relates to the sensorial tests.

The experimental results show that treating the wine with electric micro-currents with titanium anodes gives good results for the chemical maturation of wine as well as for the sensorial evolution. In fact, the differences found between the samples stored in glass and the ones stored and treated according to present invention, particularly referring to intensity and hue of colour as well as the ratio of anthocyanes transformation into stable structures associated to tannic fraction (% dTAT) clearly show a better ageing evolution of the electrically treated wine. Similarly, the decreased values reported in Table 2 with reference to the sensations of acidity, astringency and bitterness, also show a better evolution of the electrically treated wine.

TABLE 1

| | | Titanium | Titanium |
|---|---|---|---|
| | Glass | container | container |
| Analysis | container | 1 μA/m² | 10 μA/m² |
| Total Poly-phenols (mg/l) | 1443 | 2451 | 2442 |
| Free Anthocyanes (mg/l) | 79 | 73 | 70 |
| Total Flavonoids (mg/l) | 1856 | 1748 | 1732 |
| Total Anthocyanes (mg/l) | 203 | 197 | 195 |
| Non-anthocyane | 1561 | 1460 | 1449 |
| Flavonoids (mg/l) | | | |
| Protoanthocyanines (mg/l) | 2745 | 2795 | 3842 |
| Intensity | 0.81 | 0.88 | 0.89 |
| Hue | 0.73 | 0.69 | 0.65 |
| % dTAT | 46.73 | 47.75 | 49.97 |
| % dAI | 0.63 | 1.63 | 1.33 |
| % dAT | 52.64 | 50.62 | 48.70 |

In this Table, values of intensity and hue are expressed as ratio between measured values, before and after passage through a cell having piano-parallel walls, respectively of a white light beam or of a red or yellow one. Moreover, with % dTAT the transformation percentage of Anthocyanes into stable structures associated to tannic fraction (as above specified) is indicated, with % dAl the transformation percentage of free Anthocyanes, with % dAT the variation percentage of total Anthocyanes.

TABLE 2

| | | Titanium | Titanium |
|---|---|---|---|
| | Glass | container | container |
| Analysis | container | (1 μ/m²) | (10 μ/m²) |
| Wild berry (0.73) | 6.2 | 4.8 | 3.9 |
| Butter (0.32) | 3.1 | 3.0 | 3.1 |
| Toasted wood (0.68) | 2.1 | 2.0 | 1.9 |
| Vanilla (0.53) | 2.6 | 2.6 | 2.2 |
| Sweet (0.54) | 2.3 | 3.1 | 3.5 |
| Spices (0.79) | 2.1 | 3.2 | 4.2 |
| Acid (0.18) | 5.2 | 4.1 | 3.7 |
| Astringency (0.21) | 4.3 | 3.4 | 3.1 |
| Bitter (0.47) | 4.4 | 3.2 | 2.9 |
| Tobacco (0.90) | 3.4 | 2.6 | 2.4 |
| Viscosity (0.41) | 2.9 | 3.4 | 3.6 |
| Alcohol/hot (0.83) | 4.3 | 3.9 | 3.7 |
| OG wild berry (1.04) | 4.0 | 2.6 | 2.5 |
| OG toasted (0.85) | 3.0 | 2.1 | 2.1 |
| OG Butter (0.60) | 1.4 | 1.4 | 1.1 |

The invention also comprises the use of continuous electric micro-currents passed through the wine to carry out the evolution/maturation thereof.

1. Process for the controlled evolution of wines, characterised in that a wine is subjected to continuous microcurrents, made to pass through the wine itself by means of at least a couple of electrodes, cathode and anode having a value comprised between 1 and 500 μA/m² of electrode surface, at least the anode being titanium made, said cathodes and anodes being separated by means of a wall permitting the chemical separation of the anodic zone from the cathodic one, yet permitting electrical contact therebetween.

2. Process according to claim 1, in which said continuous electric micro-currents, supplied by two electrodes of which at least the anode being titanium-made, have a value comprised between 5 and 200 μA/m² of electrode surface.

3. Process according to claim 1, In which said continuous electric micro-currents, supplied by two electrodes of which at least the anode being titanium-made, have a value comprised between 10 and 100 μA/m² of electrode surface.

4. Process according to claim 1, in which said continuous electric micro-currents, supplied by two electrodes of which at least the anode being titanium-made, have a value comprised between 0,1 and 100 μA/l of wine.

5. Process according to claim 4, in which said continuous electric micro-currents, supplied by two electrodes of which at least the anode being titanium-made, have a value comprised between 0,1 and 50 μA/l of wine.

6. Process according to claim 4, in which said continuous electric micro-currents, supplied by two electrodes of which at least the anode being titanium-made, have a value comprised between 1 and 10 μA/l of wine.

7. Process according to claim 1, In which said continuous electric micro-currents are made to pass through the wine for 15 to 120 days.

8. Process according to claim 1 in which the passage of continuous electric micro-currents is carried out through the container itself, which is the titanium anode.

9. Process according to claim 1, in which the passage of continuous electric micro-currents through the wine is carried out in at least a conduit connected to said container, the wine being circulated within said conduit which contains the treatment electrodes, anode and cathode.

10. Process according to claim 9, in which said conduit is the anode and it is titanium made.

11. Process according to claim 1, in which after said first action of continuous electric micro-currents and before bottling of wine, the polarity of electrodes is inverted.

12. Process according to claim 11, in which said wall is a ceramic septum having controlled porosity.

13. Process according to claim 11, in which said wall is an ion-exchange membrane.

14. Device for the evolution of wines according to claim 1, comprising: (I) at least a container for the wine, (ii) a group of electrodes, anode and cathode, apt to make continuous electric micro-currents to pass through the wine, in which at least the anodes are titanium-made and have a high surface development; (iii) an electric power supply group, electrically connected to said electrodes and comprising means, known per se, for controlling, measuring and supplying a continuous electric current to the electrodes as well as to measure and control the electrode anodic potential.

15. Device according to claim 14, in which the container is the anode.

16. Device according to claim 14 in which at least a conduit, through which the wine is circulated, is connected to the container and contains said group of electrodes.

17. Device according to claim 14, in which said conduit is the anode.

18. Device according to claim 14, in which the surface of said anode is comprised between 10 m²1 m³ of wine and 0,1 m²/m³ of wine.

19. Device according to claim 14, in which said cathode and said anode are separated by means of a wall permitting the chemical separation of the anode from the cathode, yet permitting electrical contact.

20. Process according to claim 19, in which said wall is a ceramic septum having controlled porosity.

21. Process according to claim 19, in which said wall is an ion-exchange membrane.
